(19) United States
(12) Patent Application Publication
(10) Pub. No.: US 2026/0029730 A1
(43) Pub. Date: Jan. 29, 2026

(54) IMAGE FORMING APPARATUS

(71) Applicant: CANON KABUSHIKI KAISHA, Tokyo (JP)

(72) Inventors: Yuya Kino, Shizuoka (JP); Masatoshi Itoh, Shizuoka (JP); Satoshi Koga, Shizuoka (JP); Kazuhiko Aono, Shizuoka (JP)

(21) Appl. No.: 19/269,162

(22) Filed: Jul. 15, 2025

(30) Foreign Application Priority Data
Jul. 29, 2024 (JP) 2024-122597

(51) Int. Cl. G03G 15/08; G01F 23/22; G03G 15/00

(52) U.S. Cl. CPC G03G 15/0856; G01F 23/22; G03G 15/0865; G03G 15/80

(57) ABSTRACT

An image forming apparatus includes an image bearing member, a developer accommodating portion, a first electrode and a second electrode provided within the developer accommodating portion, a first electric contact, a second electric contact, a first substrate, and a second substrate configured to detect a detection current flowing between the first electrode and the second electrode. A minimum distance between the second substrate and the second electric contact is shorter than a minimum distance between the first substrate and the second electric contact, and wherein a distance between the second substrate and the second electric contact is shorter than a distance between the first substrate and the second electric contact in at least one of the first and second directions.

### BACKGROUND

### Field of the Technology

The present disclosure relates to an electrophotographic image forming apparatus using an electrophotographic process.

### Description of the Related Art

An electrophotographic image forming apparatus forms an image by transferring a toner image, formed on the surface of a photosensitive drum using a developer such as toner, onto a transfer material serving as a recording medium. Some of such image forming apparatuses are known to include a toner container for storing toner and toner remaining amount detection means for detecting the remaining amount of toner in the toner container.

Japanese Patent Application Publication No. 2012-108173 discloses capacitive-type toner amount detection means. In the capacitive-type detection means, for example, two electrodes are provided in the toner container to form a capacitance, and a current detection circuit connected to one of the electrodes detects the current between the electrodes to detect and acquire the remaining amount of toner.

In the capacitive-type detection of the remaining amount of developer, for example, the signal line connecting the electrode and the current detection circuit may be affected by stray capacitance between the signal line and a frame or another signal line in the vicinity, resulting in a decrease in the current detection accuracy. A decrease in the current detection accuracy leads to a decrease in the accuracy of detecting the remaining amount of developer.

### SUMMARY

The present disclosure is directed to provide an image forming apparatus capable of suppressing a decrease in the accuracy of detecting the remaining amount of developer.

According to some embodiments, an image forming apparatus of the present disclosure is characterized by features including:
an image bearing member configured to be rotatable about a rotation axis, the image bearing member having a surface on which an electrostatic latent image is formed;
a developer accommodating portion configured to accommodate a developer for developing the electrostatic latent image;
a first electrode and a second electrode provided opposite to each other within the developer accommodating portion;
a first electric contact electrically connected to the first electrode;
a second electric contact electrically connected to the second electrode;
a first substrate electrically connected to the first electric contact, the first substrate being configured to apply a voltage to the first electric contact; and
a second substrate configured separately from the first substrate and electrically connected to the second electric contact, the second substrate being configured to detect a detection current flowing between the first electrode and the second electrode,
wherein a minimum distance between the second substrate and the second electric contact is shorter than a minimum distance between the first substrate and the second electric contact, and
wherein in a case where a direction of the rotation axis is a first direction, a direction of gravity is a third direction, and a direction perpendicular to both the first and third directions is a second direction, a distance between the second substrate and the second electric contact is shorter than a distance between the first substrate and the second electric contact in at least one of the first and second directions.

According to the present disclosure, an image forming apparatus capable of suppressing a decrease in the accuracy of detecting the remaining amount of developer can be provided.

Features of the present disclosure will become apparent from the following description of embodiments with reference to the attached drawings. The following description of embodiments is described by way of example.

### BRIEF DESCRIPTION OF THE DRAWINGS

FIG. 1 is a schematic cross-sectional view of the configuration of an image forming apparatus according to a first embodiment;

FIG. 2 is a block diagram of the configuration of a toner remaining amount detection device according to a comparative example.

FIG. 3 is a diagram illustrating the arrangement of a toner remaining amount detection device according to a first embodiment;

FIG. 4 is a view illustrating the arrangement of the toner remaining amount detection device according to the first embodiment;

FIG. 5 is a block diagram of the configuration of the toner remaining amount detection device according to the first embodiment; and

FIG. 6 is a view illustrating a toner remaining amount detection device according to a second embodiment.

### DESCRIPTION OF THE EMBODIMENTS

Hereinafter, a description will be given, with reference to the drawings, of various exemplary embodiments (examples), features, and aspects of the present disclosure. However, the sizes, materials, shapes, their relative arrangements, or the like of constituents described in the embodiments may be appropriately changed according to the configurations, various conditions, or the like of apparatuses to which the disclosure is applied. Therefore, the sizes, materials, shapes, their relative arrangements, or the like of the constituents described in the embodiments do not intend to limit the scope of the disclosure to the following embodiments.

In the following description, the present disclosure is applied to an electrophotographic image forming apparatus that forms an image on a recording medium using an electrophotographic image forming process. Examples of electrophotographic image forming apparatuses may include electrophotographic copiers, electrophotographic printers (such as LED printers and laser beam printers), and electrophotographic facsimile machines.

### First Embodiment

### Image Forming Apparatus

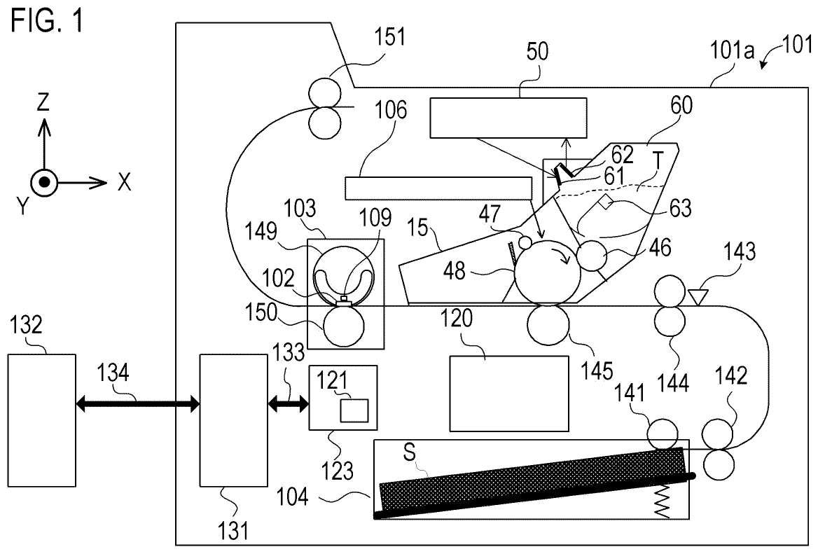

An image forming apparatus 101 according to a first embodiment of the present disclosure will be described. The image forming apparatus 101 is a laser beam printer using an electrophotographic process. FIG. 1 is a schematic cross-sectional view of an overall configuration of the image forming apparatus 101 according to the first embodiment.

In the following description and drawings, the depth direction of the image forming apparatus 101 is defined as the X direction, the width direction as the Y direction, and the vertical direction as the Z direction. The X, Y, and Z directions intersect with one another (being perpendicular to each other in the first embodiment), and when the image forming apparatus 101 is placed on a horizontal mounting surface, the vertical direction (Z direction) is parallel to the direction of gravity.

The image forming apparatus 101 includes a sheet feed cassette 104 that stores a recording material S serving as a recording medium. The image forming apparatus 101 further includes a sheet feed roller 141 that feeds the recording material S from the sheet feed cassette 104, a pair of conveyance rollers 142, a top sensor 143 that detects the leading edge of the recording material S, and a pair of registration rollers 144 that synchronously convey the recording material S. These components are arranged in the order of the sheet feed roller 141, the pair of conveyance rollers 142, the top sensor 143, and the pair of registration rollers 144 from the upstream side in the conveyance direction of the recording material S. In the following description, unless otherwise specified, the conveying direction refers to the direction in which the recording material S fed from the sheet feed roller 141 is conveyed.

A cartridge 15 detachably attached to the apparatus body 101a of the image forming apparatus 101 is provided downstream of the pair of registration rollers 144 in the conveyance direction. The cartridge 15 forms a toner image on the recording material S on the basis of a laser beam from a laser scanner 106.

The cartridge 15 includes components required for the electrophotographic process, such as a photosensitive drum 48, a primary charging roller 47, and a developing roller 46. The cartridge 15 also includes a toner container (developer accommodating portion) 60 that accommodates toner T therein as a developer.

The photosensitive drum 48 is an electrostatic latent image bearing member which is rotatably supported about its rotation axis and on the surface of which an electrostatic latent image is formed. The developing roller 46 is a supply member for supplying the toner accommodated in a toner container 60 to the surface of the photosensitive drum 48. The primary charging roller 47 charges the photosensitive drum 48. An electrostatic latent image is formed on the surface of the photosensitive drum 48, and the electrostatic latent image is developed by the toner T supplied by the developing roller 46. In this way, the toner image is formed on the surface of the photosensitive drum 48.

A transfer roller 145 is provided at a position facing the photosensitive drum 48. The photosensitive drum 48 and the transfer roller 145 form a transfer nip. The toner image formed on the surface of the photosensitive drum 48 is transferred onto the recording material S at the transfer nip.

The image forming apparatus 101 includes a heat fixing unit 103 for thermally fixing a toner image formed on the recording material S. The heat fixing unit 103 is a heating device having a fixing film 149, a pressure roller 150, a heater 102 provided inside the fixing film 149, and a thermistor 109 provided near the heater 102 so as to detect the temperature of the heater 102 in the fixing film 149. The heat fixing unit 103 is provided downstream of the cartridge 15 in the conveying direction.

The image forming apparatus 101 includes a pair of sheet discharge rollers 151 that discharge, to the outside, the recording material S having the toner image thermally fixed thereon. The pair of discharge rollers 151 are provided downstream of the heat fixing unit 103 in the conveying direction.

The image forming apparatus 101 includes a power supply unit (power supply device) 120. The power supply unit 120 can switch, as appropriate, between voltages of 24 V and 10 V for output, and generates a voltage of 24 V in a print mode or standby mode. Then, the 24 V voltage is supplied as a drive system voltage to components such as a drive unit (not shown) including a motor and a clutch, a high-voltage power source (not shown) for supplying high voltage to the cartridge 15, and a polygon mirror drive portion (not shown) of the laser scanner 106. Voltage supply from the power supply unit 120 to each drive portion is performed via a control portion 123.

The image forming apparatus 101 includes the control portion 123 that controls the operation of the image forming apparatus 101. The control portion 123 functions as an engine controller that controls the drive unit to operate the individual rollers that constitute the conveyance portion for the recording material S, thereby controlling the conveyance of the recording material S. The control portion 123 also controls various components such as the laser scanner 106, the cartridge 15, and the heat fixing unit 103 to perform image forming operation (hereinafter referred to as “printing”). The control portion 123 may also perform various types of processing (such as calculating the remaining amount of toner) as described below. The control portion 123 may be a processing device having a computing resource such as a processor and a memory.

A DC-DC converter 121 is mounted in the control portion 123 and generates a voltage of 3.3 V, which is mainly used in the control system, on the basis of the voltage supplied from the power supply unit 120. The 3.3 V voltage is supplied to control-system-related circuits, including a control circuit (not shown) inside the control portion 123, a video controller 131 to be described below, a laser emitting portion (not shown) of the laser scanner 106, and the top sensor 143.

The image forming apparatus 101 includes the video controller 131. The video controller 131 is connected to the control portion 123 via an engine interface 133 and to an external device 132 such as a personal computer via a general-purpose external interface 134 (e.g., USB).

The video controller 131 receives print information (such as the number of sheets and various settings) and print data from the external interface 134. Then, the video controller 131 uses an image control portion provided inside (not shown) to convert the print data into image data suitable for printing. Thereafter, the control portion 123 is configured to receive the image data from the video controller 131 via the engine interface 133 at a prescribed timing and send the image data to the laser scanner 106.

The cartridge 15 is a toner cartridge including the toner container 60 that accommodates the toner T. The first electrode 61 and the second electrode 62 which form a capacitance and the toner agitation member 63 are provided in the toner container 60. The first electrode 61 and the second electrode 62 are arranged opposite to each other within the toner container 60.

When the toner T in the toner container 60 is agitated by the toner agitation member 63, the toner T moves in and out of a space between the first electrode 61 and the second electrode 62 (facing space). The capacitance between the first electrode 61 and the second electrode 62 varies as the toner T moves in and out. In the first embodiment, the change in capacitance caused by the inflow and outflow of toner Tis utilized to detect a current flowing between the first electrode 61 and the second electrode 62, and the control portion 123 detects the remaining amount of toner on the basis of the detected current.

The image forming apparatus 101 includes a toner remaining amount detection portion 50 that causes a current to flow between the first electrode 61 and the second electrode 62 and detects the remaining amount of toner on the basis of the detected current. The toner remaining amount detection portion 50 includes components such as a plurality of electric contacts, a circuit for outputting a voltage, and a circuit for detecting a current. The structure of the toner remaining amount detection portion 50 will be described in detail later.

### Toner Remaining Amount Detection Device in Comparative Example

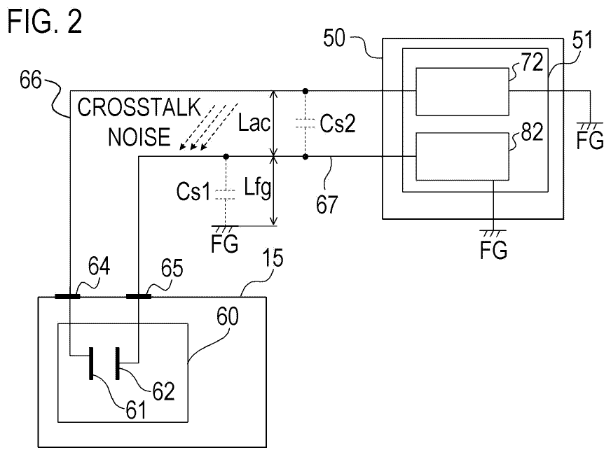

Prior to the description of the toner remaining amount detection device according to the first embodiment, the toner remaining amount detection device according to a comparative example will be described. FIG. 2 is a block diagram of the configuration of a toner remaining amount detection device of the electrostatic residue detection type according to the comparative example.

The toner remaining amount detection device according to the comparative example includes a toner remaining amount detection portion 50, a first electrode 61, a second electrode 62, a first electric contact 64 electrically connected to the first electrode 61, a second electric contact 65 electrically connected to the second electrode 62, and a control portion 123.

The toner remaining amount detection portion 50 includes a toner remaining amount detection substrate 51 including an AC voltage output circuit 72 and a current detection circuit 82. The AC voltage output circuit 72 is electrically connected to the first electric contact 64 and configured to output (generate) a voltage to be applied to the first electric contact 64. The current detection circuit 82 is electrically connected to the second electric contact 65 and configured to detect a current flowing between the first electrode 61 and the second electrode 62. More specifically, the toner remaining amount detection portion 50 functions as both an AC voltage output portion and a current detection portion.

The first electrode 61 and the second electrode 62 are provided in the toner container 60. The first electric contact 64 and the second electric contact 65 are provided on the surface of the cartridge 15. The first electric contact 64 is electrically connected to the first electrode 61 and is connected to the AC voltage output circuit 72 via a signal line (AC voltage line) 66. The second electric contact 65 is electrically connected to the second electrode 62 and is connected to the current detection circuit 82 via a signal line 67. The signal line 67, the AC voltage output circuit 72, and the current detection circuit 82 are connected to respective frame GNDs (grounds). In the following description and drawings, the frame GND is simply referred to as FG.

The AC voltage generated by the AC voltage output circuit 72 is applied to the first electric contact 64 via the signal line 66, causing a current to flow in accordance with the capacitance between the first electrode 61 and the second electrode 62. The current flowing between the first electrode 61 and the second electrode 62 flows into the current detection circuit 82 via the signal line 67. The current detection circuit 82 detects the current, and the control portion 123 acquires the remaining amount of toner on the basis of the detected current.

If the capacitance between the first electrode 61 and the second electrode 62 is small, the current flowing into the current detection circuit 82 becomes small. Then, the signal line 67 between the second electrode 62 and the current detection circuit 82 is significantly affected by stray capacitance Cs1 formed between the FG and the signal line 67, and stray capacitance Cs2 formed between the signal line 67 and the signal line 66 extending from the AC voltage output circuit 72 to the first electrode 61. The signal line 67 is also susceptible to noise attributable to crosstalk with the signal line 66 and other signal lines. When the signal line 67 is affected in this way, the accuracy of current detection by the current detection circuit 82 decreases, making it difficult to accurately detect and acquire the remaining amount of toner.

The distance Lfg between signal line 67 and the FG, the distance Lac between signal lines 67 and 66, and the distance between signal line 67 and other signal lines must be sufficiently large to reduce the influence of stray capacitance and crosstalk noise. However, increasing the distance between the signal line 67 and other components is not preferable, as it may result in a larger toner remaining amount detection device and, consequently, a larger image forming apparatus 101.

### Toner Remaining Amount Detection Device in First Embodiment

Next, the toner remaining amount detection device according to the first embodiment will be described. In the comparative example, the AC voltage output circuit 72 and the current detection circuit 82 are provided on one substrate (the toner remaining amount detection substrate 51), while in the first embodiment, the AC voltage output circuit 72 and the current detection circuit 82 are provided on two separate substrates positioned apart from each other. In the following description of the toner remaining amount detection device according to the first embodiment, the same components as those in the comparative example will be denoted with the same reference numerals, and descriptions thereof will not be provided.

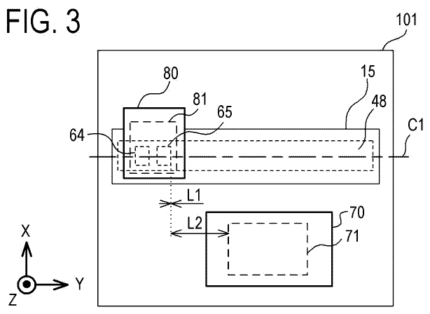

FIG. 3 illustrates the arrangement of the toner remaining amount detection device of the electrostatic residue detection type according to the first embodiment when the image forming apparatus 101 is viewed from above in the direction of gravity. The toner remaining amount detection device according to the first embodiment includes an AC power output portion 70 including a first substrate (voltage output substrate) 71 and a current detection portion 80 including a second substrate (current detection substrate) 81 provided separately from the first substrate 71. The first substrate 71 has the AC voltage output circuit 72 and applies a voltage to the first electric contact 64. The second substrate 81 has the current detection circuit 82 and detects detection current flowing between the first electrode 61 and the second electrode 62.

In the first embodiment, the current detection portion 80 is provided above (directly above) the cartridge 15. More specifically, when viewed in the direction of gravity, the second substrate 81 is positioned to overlap the cartridge 15. The first electric contacts 64 and the second electric contact 65 are provided on the surface of the cartridge 15. The first electric contact 64 and the second electric contact 65 are arranged side by side in a direction parallel to the rotation axis C1 of the photosensitive drum 48.

When viewed in the direction of gravity, both the first and second electric contacts 64 and 65 are positioned to overlap the second substrate 81 of the current detection portion 80 and the photosensitive drum 48 of the cartridge 15. Meanwhile, the AC voltage output portion 70 including the first substrate 71 is positioned not to overlap the first electric contact 64, the second electric contact 65, and the cartridge 15 when viewed in the direction of gravity.

As shown in FIG. 3, the second substrate 81 of the current detection portion 80 is provided closer to the second electric contact 65 than the first substrate 71 of the AC voltage output portion 70, in a direction (first direction, the Y direction) parallel to the rotation axis C1 of the photosensitive drum 48. More specifically, in the direction parallel to the rotation axis C1 (first direction, the Y direction), the distance between the second substrate 81 and the second electric contact 65, referred to as a first distance L1, is shorter than the distance between the first substrate 71 and the second electric contact 65, referred to as a second distance L2. In the first embodiment, the first distance L1 is zero because the second substrate 81 and the second electric contact 65 overlap when viewed in the direction of gravity. Furthermore, in the first embodiment, in the direction parallel to the rotation axis C1 (first direction, the Y direction), the distance between the second substrate 81 and the first electric contact 64 is shorter than the distance between the first substrate 71 and the first electric contact 64.

In the first embodiment, the second substrate 81 is also provided closer to the second electric contact 65 than the first substrate 71 in a direction (second direction, the X direction) perpendicular to both the rotation axis C1 of the photosensitive drum 48 and the direction of gravity. In other words, in the direction perpendicular to both the rotation axis C1 and the direction of gravity (second direction, X direction), the distance between the second substrate 81 and the second electric contact 65 is shorter than the distance between the first substrate 71 and the second electric contact 65. Similarly, in the direction perpendicular to both the rotation axis C1 and the direction of gravity (second direction, X direction), the distance between the second substrate 81 and the first electric contact 64 is shorter than the distance between the first substrate 71 and the first electric contact 64.

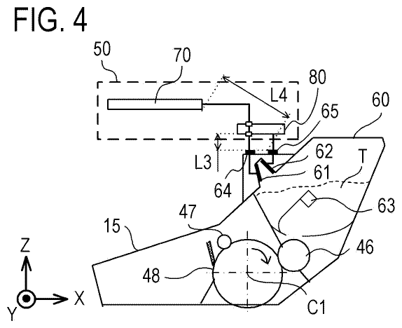

FIG. 4 is a view illustrating the arrangement of the toner remaining amount detection device of the electrostatic residue detection type according to the first embodiment and illustrates the toner remaining amount detection portion 50 and the cartridge 15 as viewed in the direction of the rotation axis C1 of the photosensitive drum 48. In FIG. 4, only the main components are shown in order to show the positional relationship between the toner remaining amount detection portion 50 and the cartridge 15. The first electric contact 64 and the second electric contact 65 are arranged side by side in the direction (Y direction) parallel to the rotation axis C1 of the photosensitive drum 48 as shown in FIG. 3, while these contacts are shown shifted in the Y direction to show their connection relationship in FIG. 4.

As shown in FIG. 4, the second substrate 81 is provided closer to the second electric contact 65 than the first substrate 71 in the direction perpendicular to the rotation axis C1. More specifically, in the direction perpendicular to the rotation axis C1, a third distance L3 that is the shortest distance between the second substrate 81 and the second electric contact 65 is shorter than a fourth distance L4 that is the shortest distance between the first substrate 71 and the second electric contact 65. Similarly, in the direction perpendicular to the rotation axis C1, the distance between the second substrate 81 and the first electric contact 64 is shorter than the distance between the first substrate 71 and the first electric contact 64.

Also, as shown in FIG. 4, in the first embodiment, in a prescribed direction (for example, the second direction) perpendicular to the rotation axis C1, the distance between the second substrate 81 and the second electric contact 65 is shorter than the distance between the first substrate 71 and the second electric contact 65. In a direction (third direction, for example, the Z-direction) perpendicular to both the direction of the rotation axis C1 (first direction) and the prescribed direction (second direction) perpendicular to the rotation axis C1, the distance between the second substrate 81 and the second electric contact 65 is shorter than the distance between the first substrate 71 and the second electric contact 65. In this way, in the first embodiment, in each of the first direction, the second direction, and the third direction, the second substrate 81 is provided closer to the second electric contact 65 than the first substrate 71. The components are arranged so that the shortest distance between the second substrate 81 and the second electric contact 65 is shorter than the shortest distance between the first substrate 71 and the second electric contact 65.

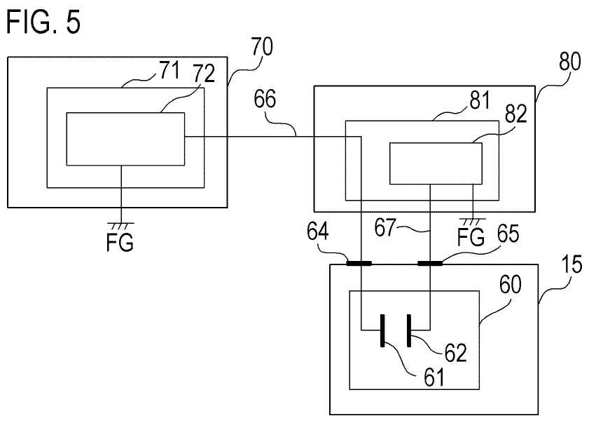

FIG. 5 is a block diagram of the configuration of the toner remaining amount detection device according to the first embodiment. The first substrate 71 of the AC voltage output portion 70 has the AC voltage output circuit 72. The second substrate 81 of the current detection portion 80 has the current detection circuit 82. The first substrate 71 and the second substrate 81 are respectively connected to the FGs.

The first electric contact 64 electrically connected to the first electrode 61 and the second electric contact 65 electrically connected to the second electrode 62 are connected to the second substrate 81 of the current detection portion 80. The first electric contact 64 is electrically connected to the AC voltage output circuit 72 in the AC voltage output portion 70 via the second substrate 81. This configuration enables connection of the signal lines 66 and 67 to the second substrate 81 via similar paths, thereby reducing wiring space.

In the configuration of the first embodiment, the AC voltage output portion 70 and the current detection portion 80 are electrically connected by a cable, and the current detection portion 80 and the first electric contact 64, and the second electric contact 65 are electrically connected by a contact spring. Note that the electrical connection arrangement is not limited to this arrangement, and other connection members (connection means) may be used instead as long as the members can be electrically connected. In the first embodiment, the first substrate 71 of the AC voltage output portion 70 is connected to the first electric contact 64 via the second substrate 81 of the current detection portion 80, but the first substrate 71 may be connected to the first electric contact 64 without passing through the second substrate 81.

When considering which of the first substrate 71 and the second substrate 81 should be arranged closer to the second electric contact 65, in the first embodiment, the second substrate 81 is arranged closer to the second electric contact 65 than the first substrate 71 of the AC voltage output portion 70. As a result, since the distance of the signal line 67 connecting the current detection circuit 82 and the second electrode 62 is shortened, the influence of stray capacitance generated between the signal line 67 and other potentials, as well as crosstalk noise from other signals, can be reduced. Accordingly, it is possible to suppress a decrease in current detection accuracy, and to suppress a decrease in the accuracy of detecting the remaining amount of toner.

Since the signal line 67 is shortened, it is possible to reduce the space required for securing the distance between the signal line 67 and another signal line (such as Lfg or Lac in FIG. 2), which is secured in the comparative example. In addition, by separating the second substrate 81 included in the current detection portion 80, the size of the current detection portion 80 can be reduced, making it easier to arrange the current detection portion 80 near the second electric contact 65. Then, the first substrate 71 included in the AC voltage output portion 70 and the second substrate 81 included in the current detection portion 80 are provided independently from each other, so that the AC voltage output portion 70 and the current detection portion 80 can be arranged separately from each other. Accordingly, the current detection portion 80 can be made less susceptible to noise generated in the AC voltage output circuit 72.

As described above, according to the first embodiment, arranging the current detection portion 80 near the second electric contact 65 enables the image forming apparatus 101 to achieve high toner remaining amount detection accuracy and contributes to downsizing the apparatus. The first electrode 61 and the second electrode 62 are provided exclusively for the capacitive configuration in the first embodiment, but the first electrode 61 may alternatively be used as an electrode connected to a component such as the developing roller 46 (supply member). By sharing the electrode, the number of electrodes to be arranged can be reduced, which contributes to a further reduction in the size of the apparatus. For the same reason, the first electric contact 64 may be configured to receive power to be supplied to the developing roller 46 from the apparatus body 101a.

In the first embodiment, the distance between the second substrate 81 and the second electric contact 65 is shorter than the distance between the first substrate 71 and the second electric contact 65 in both the direction of the rotation axis C1 (first direction) and the prescribed direction (second direction) perpendicular to the rotation axis C1. However, if, for example, the distance between the second substrate 81 and the second electric contact 65 is shorter than the distance between the first substrate 71 and the second electric contact 65 in at least one of the first direction and the second direction, the effect of suppressing a decrease in the accuracy of detecting the remaining amount of toner is higher than that in the reverse arrangement. This is because, in at least one of the first direction and the second direction, the second substrate 81 is arranged closer to the second electric contact 65 than the first substrate 71, so that the signal line 67 connecting the current detection circuit 82 of the second substrate 81 and the second electric contact 65 can be shortened. More specifically, it is only required that the shortest distance between the second substrate 81 and the second electric contact 65 is shorter than the shortest distance between the first substrate 71 and the second electric contact 65, and the distance between the second substrate 81 and the second electric contact 65 is shorter than the distance between the first substrate 71 and the second electric contact 65 in at least one of the first, second and third directions.

### Second Embodiment

A second embodiment of the present disclosure will now be described. The second embodiment is different from the first embodiment in the support arrangement of the second substrate 81. Only the differences in the configuration of the second embodiment from that of the first embodiment will be described below. In the configuration of the second embodiment, the same components as those of the first embodiment are denoted by the same reference numerals, and their descriptions will not be provided. In the second embodiment, failures of electronic components attributable to electrostatic discharge (ESD) in the current detection portion 80 can be suppressed.

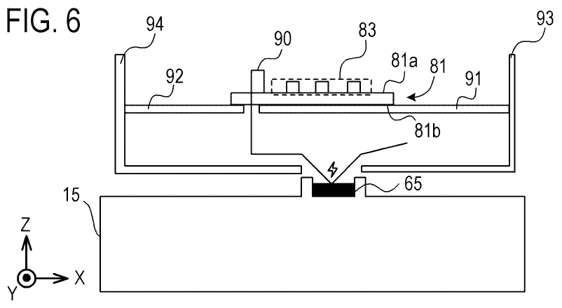

The configuration of the second embodiment will be described below with reference to FIG. 6. FIG. 6 illustrates a toner remaining amount detection device according to the second embodiment and is a view of the image forming apparatus 101 as viewed in the direction of the rotation axis C1 of the photosensitive drum 48. FIG. 6 shows the positional relationship between the cartridge 15 and the second substrate 81 of the current detection portion 80. Electronic components 83 to constitute the current detection circuit 82 are mounted on the second substrate 81 of the current detection portion 80.

Support members 91 and 92 for supporting the second substrate 81 are attached to the second substrate 81. The support member 91 is connected to a protective member 93, and the support member 92 is connected to the protective member 94. The protective members 93 and 94 are both parts connected to the apparatus body 101a of the image forming apparatus 101. That is, the second substrate 81 is attached to the apparatus body 101a of the image forming apparatus 101 by the support members 91, 92 and the protective members 93 and 94.

The cartridge 15, which can be detachably attached to the apparatus body 101a of the image forming apparatus 101, is arranged below the second substrate 81. When the cartridge 15 is attached to the apparatus body 101a, the second electric contact 65 and the second substrate 81 are connected by a contact spring 90.

The second substrate 81 has a first surface 81a on which the electronic components 83 are provided, and a second surface 81b which is a rear surface of the first surface 81a. The second substrate 81 is arranged so that the second surface 81b faces the electric contact side (the side of the first electric contact 64 and the second electric contact 65). That is, in the second embodiment, the first surface 81a faces upward in the direction of gravity, and the second surface 81b faces downward in the direction of gravity.

In addition to the contact spring 90 as a connection member, the protective member 93 and the protective member 94 are provided in the space between the second substrate 81 and the second electric contact 65. The protective members 93 and 94 are provided so as to cover the second surface 81b of the second substrate 81 while securing a space through which a connection member such as the contact spring 90 passes and constitutes a protective portion for protecting the second substrate 81.

More specifically, the second substrate 81 is arranged so that the first surface 81a, on which the electronic components 83 are provided, faces the side opposite to the second electric contact 65, and the lower portion of the second substrate 81 is covered, except for part thereof, by the protective members 93 and 94. With this configuration, even if ESD occurs at the first electric contact 64 or the second electric contact 65 due to user operation during attachment or detachment of the cartridge 15, the second substrate 81 can serve as a barrier for the electronic components 83, thereby suppressing damage caused by ESD air discharge.

As described above, according to the second embodiment, in addition to suppressing a decrease in the accuracy of detecting the remaining amount of toner, it is possible to suppress failures of the electronic components 83 caused by ESD resulting from user operation.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-122597, filed Jul. 29, 2024, which is hereby incorporated by reference herein in its entirety.

What is claimed is:

1. An image forming apparatus comprising:
an image bearing member configured to be rotatable about a rotation axis, the image bearing member having a surface on which an electrostatic latent image is formed;
a developer accommodating portion configured to accommodate a developer for developing the electrostatic latent image;
a first electrode and a second electrode provided opposite to each other within the developer accommodating portion;
a first electric contact electrically connected to the first electrode;
a second electric contact electrically connected to the second electrode;
a first substrate electrically connected to the first electric contact, the first substrate being configured to apply a voltage to the first electric contact; and
a second substrate configured separately from the first substrate and electrically connected to the second electric contact, the second substrate being configured to detect a detection current flowing between the first electrode and the second electrode,
wherein a minimum distance between the second substrate and the second electric contact is shorter than a minimum distance between the first substrate and the second electric contact, and
wherein in a case where a direction of the rotation axis is a first direction, a direction of gravity is a third direction, and a direction perpendicular to both the first and third directions is a second direction, a distance between the second substrate and the second electric contact is shorter than a distance between the first substrate and the second electric contact in at least one of the first and second directions.

2. The image forming apparatus according to claim 1, wherein
a distance between the second substrate and the second electric contact is shorter than a distance between the first substrate and the second electric contact in the third direction.

3. The image forming apparatus according to claim 1, wherein
the second substrate has a first surface on which an electronic component is provided, and a second surface opposite to the first surface, the second surface being arranged to face the second electric contact.

4. The image forming apparatus according to claim 3, wherein
the electronic component constitutes a current detection circuit configured to detect the detection current.

5. The image forming apparatus according to claim 3, further comprising:
a connection member configured to electrically connect the second substrate and the first electric contact, and
a protective member provided to cover the second surface of the second substrate while ensuring a space through which the connection member passes.

6. The image forming apparatus according to claim 1, wherein
the first electric contact is electrically connected to the first substrate via the second substrate.

7. The image forming apparatus according to claim 1, further comprising:
an apparatus body on which the first substrate and the second substrate are provided; and
a cartridge including the image bearing member, the developer accommodating portion, the first electric contact, and the second electric contact, the cartridge being detachably attached to the apparatus body.

8. The image forming apparatus according to claim 7, wherein
the second substrate is provided above the cartridge and is positioned to overlap the cartridge when viewed in the direction of gravity.

9. The image forming apparatus according to claim 8, wherein
the first substrate is positioned so as not to overlap the cartridge as viewed in the direction of gravity.

10. The image forming apparatus according to claim 1, further comprising:
an apparatus body on which the first substrate, the second substrate, and the image bearing member are provided; and
a cartridge including the developer accommodating portion, the first electric contact, and the second electric contact,
wherein the cartridge is detachably attached to the apparatus body.
